(19) United States
(12) Patent Application Publication
(10) Pub. No.: US 2011/0035253 A1
(43) Pub. Date: Feb. 10, 2011

(54) Systems and Methods for Optimizing Enterprise Performance Relationships to Other Applications

(75) Inventors: Steven J. Mason, Nashville, TN (US); Ronald E. Galbraith, Nashville, TN (US)

Correspondence Address: The Marbury Law Group, PLLC, 11800 SUNRISE VALLEY DRIVE, SUITE 1000, RESTON, VA, 20191, US

(73) Assignee: onFucus Healthcare, Brentwood, TN (US)

(21) Appl. No.: 12/850,880

(22) Filed: Aug. 5, 2010

Related U.S. Application Data
(60) Provisional application No. 61/232,056, filed on Aug. 7, 2009.

(51) Int. Cl. G06Q 10/00

(52) U.S. Cl. 705/9; 705/7

(57) ABSTRACT

Methods and systems enable enterprises to optimize the performance of an organization or enterprise by linking the goals and the performance of the organization or enterprise. Goals may be set for improving performance. Those goals may then be evaluated using parameters such as critical success factors, key performance indicators, and action plan steps.

### RELATIONSHIP TO OTHER APPLICATIONS

This application claims the benefit of a provisional application 61/232,056 filed on Aug. 7, 2009, which application is incorporated herein in its entirety for all purposes.

### BACKGROUND

Today, organizational discipline and the leadership culture to assure execution of plans and projects remain absent or variable in a large percentage of enterprises and organizations. This may be a result of conflicting demands, shrinking resources and best intentions. This problem is further exacerbated by the lack of tools to assist in setting goals appropriate to the organization and to monitor effective execution of an organization's plans and projects. An enterprise that can demonstrate organizational discipline and a predictable pathway of execution will have a competitive advantage when securing capital and attracting investors.

### SUMMARY

The various embodiments provide systems and methods for optimizing the performance of an organization or enterprise.

In an embodiment, a rules engine is configured to generate and execute rules for a particular organizational structure or business model. By way of illustration and not by way of limitation, the organization may be a healthcare enterprise, a manufacturing enterprise, or a service enterprise. In this embodiment, the rules engine facilitates the setting of goals and the assigning of critical success factors and key performance indicators to each goal. The rules engine may be configured to generate one or more action steps for each goal, the achievement of which may determine a measure of progress by the organization. The achievement of actions steps may be measured by integrating metrics tools and using data received from the metrics tools and progress report inputs from project leaders which is then automatically tracked on a constant basis to measure progress. The metrics data may be analyzed by analytical tools or by considering analytical data received from analytical tools. The various embodiment methods and systems may also enable users to receive progress data, suggested strategic plans based on analyzed data and allow users to change or upgrade data and equipment in the system to improve and optimize performance of the organization.

In an embodiment, an optimization system may automatically optimize enterprise and/or organization performance. Accordingly, an enterprise or organization may provide their organization type, data, and based on that information, the optimization system may automatically generate or retrieve from a pre-set goal database goals relevant to the enterprise or organization. The healthcare optimization system may also generate or retrieve from a pre-set database critical success factors (CSF) and key performance indicators (KPI) for each goal. The optimization system may also create or retrieve from a pre-set database action steps that may be taken to achieve each goal. Metrics data and other data such as user notes and input may be collected or retrieved from a database and analyzed using analytical tools and/or data. Data may be collected and analyzed by the healthcare optimization system over a period of time, and based on the data, goals, critical success factors, key performance indicators, and actions plans may be added, deleted, or changed. The system may periodically, or upon receiving a request, generate reports about the performance of the enterprise or organization.

### DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a system component diagram for optimizing the performance of an enterprise or organization according to various embodiments.

FIGS. 2-7 are a block diagram illustrating a library of Key Performance Indicators (KPI) suitable for use with the various embodiments.

FIG. 8 is a table of data according to the various embodiments.

FIG. 9 is a process flow diagram for setting goals and evaluating progress in achieving those goals according to the various embodiments.

FIG. 10 is a system component diagram for optimizing the performance of an enterprise or organization according to an embodiment.

FIG. 11 is a process flow diagram of an embodiment method for automatically generating goals and monitoring performance of an enterprise or organization for achieving those goals according to an embodiment.

FIG. 12 is a component block diagram of a server device suitable for use in the various embodiments.

FIG. 13 is a component block diagram of computing devices suitable for use in the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration. Any implementation described herein as “exemplary” is not necessarily to be construed as preferred or advantageous over other implementations.

The term “strategic performance goal” as used herein encompasses a major goal and strategic priorities determined to be relevant to achieving the long-term objectives or an enterprise or organization.

That term “area” or “focus” as used herein encompasses an area or a focus of a strategic performance goal.

The term “leader” or “manager” as used herein encompasses an individual responsible and accountable to achieve a specific strategic goal on action plan created to achieve a critical success factor.

The term “target end date” as used herein encompasses a date that the goal, success factor, or action item must be successfully achieved.

The term “critical success factor” (CSF) as used herein encompasses tasks the completion of which may be necessary in order to achieve a particular goal.

The term “key performance Indicator” (KPI) as used herein encompasses one or more key performance indicators that measure the status of a success factor. Each KPI typically may include specifically defined targets or “acceptable ranges” that must be met or maintained in order for the goal to be achieved.

The term “action plan” as used herein encompasses a clear, step-by-step action plan for achieving a critical success factor. The term “achievement indicator” as used herein encompasses a desired outcome or output of an action step within an action plan.

In the discussion below, various embodiments are illustrated in the context of a healthcare organization. However, the description is not intended to be limiting. The various features and methods described below may be applied to any enterprise or organization for which goals, critical success factors and key performance indicators may be defined.

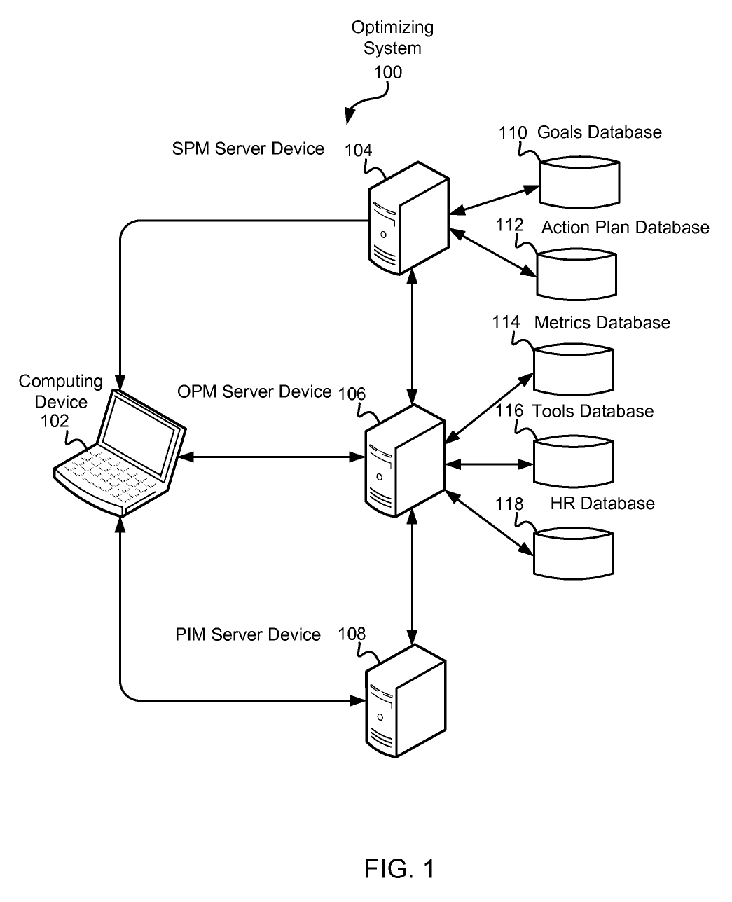

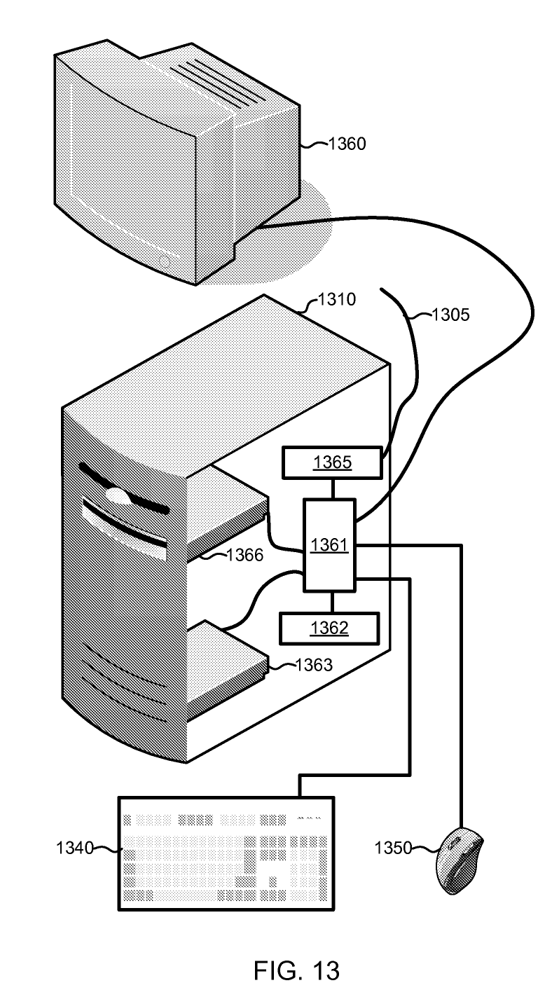

FIG. 1 illustrates a system component diagram for an optimizing system according to the various embodiments. According to FIG. 1, an optimization system 100 may include a computing device 102, such as a Personal Computer (PC), which may be configured with software instructions to allow users to input and receive data and communicate with the other components of the optimization system 100. The software instructions may be executed by one or more processors (see, FIG. 13). The computing device 102 may communicate with other components of the optimization system 100 by wire, wirelessly or via the internet. Other communication methods are known and contemplated.

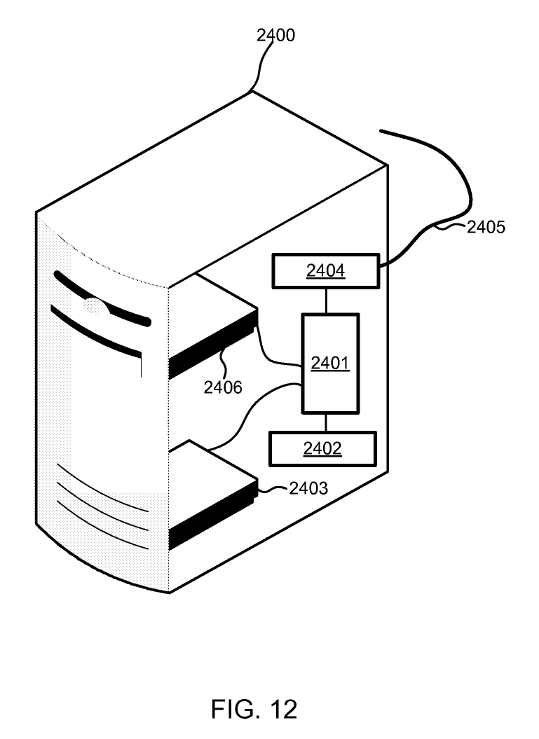

The optimization system 100 may include a strategic performance management (SPM) 104 server device configured with software instructions to allow leaders of an enterprise or organization to drive and ensure successful strategy execution throughout the entire enterprise or organization. The software instructions may be executed by one or more processors (see, FIG. 12).

The SPM server device 104 may be configured with software instructions to request and receive strategic plan data including strategic goals, action plan steps, critical success factors (CSFs) and key performance indicators (KPI). Additionally, server device 104 may comprise rules for establishing KPIs based upon a type of enterprise or organization that is inputted by a user. For example, and without limitations, the KPI for a local clinic may differ from a regional hospital. The server device 104 comprises rules for suggesting the KPI that is appropriate to the enterprise or organization.

The SPM server device 104 may be configured with software instructions to request goals data from the user. Goals data may include information about a projected operating state that an enterprise or organization plans to achieve. Examples of goals may include financial, operational, clinical, quality, safety, compliance, employee/H. R., and staff relation goals. One or several goals may be set to achieve an objective. Goals may therefore include intermediary or final goals. For example, a healthcare organization may set a final financial goal to reduce cost by 20% in a time span of three years.

Similarly, several goals may be set for the same project to show progress towards a final objective. For example, using the same example as above, a healthcare organization may set a final goal of reducing costs by 20% in three years. In addition, the same healthcare organization may set intermediary goals to, for example, achieve reduction of 5% in costs during the first year and 10% during the second year. These intermediary goals may allow a healthcare organization to track progress and to ensure that the final goal is timely achieved. The intermediary goals may also allow a healthcare organization to evaluate its overall progress towards the final goal and make any necessary adjustments to either achieve the final goal, or change the parameters of the final goal to render it more realistic.

Other examples of a goal data for a healthcare organization may include re-establishing a hospitals patient safety focus while continuing to improve quality of care and care delivery, improving healthcare organization financial performance and increasing healthcare organizations market share.

Alternatively, or in addition, the SPM server device 104 may be configured with software instructions to operate a rules engine to retrieve goals from one or several databases that store predetermined or pre-set goals such as a goals database 110. In an embodiment, the goals database 110 may include enterprise and/or organization specific goals that enterprise or organization within a particular category may use to set final or intermediate goals.

In the task of setting goals, the server device 104 may also comprise a rules engine for suggesting certain goals for the enterprise or organization type. For example, in the case of a local clinic, the rules engine in the server device 104 would not suggest installation of an MRI machine. It may, however, suggest obtaining a supply of certain types of vaccines that can be routinely given to a local population. Similarly, for a large regional hospital, the rules engine in the server device 104 may suggest more sophisticated pieces of equipment for installation as well as suggest to the healthcare organization's management the various regulations for which compliance would be required.

The SPM server device 104 may also be configured with software instructions to suggest request and receive CSFs that are germane to the enterprise and/or organization type. CSFs may include critical components that are necessary in order to achieve a strategic goal. For example, a CSF for achieving the goal of reducing company costs by 20% in three years may be a reduction in the number of employees. Project managers may enter CSFs into the optimization system 100 or CSFs may be selected from a database based upon the enterprise or organization type which may include predetermined CSFs for each specific goal.

The SPM server device 104 may also be configured with software instructions to operate a rules engine that suggests various key performance indicators (KPIs) based upon the healthcare enterprise and/or organization type. The SMP server device 104 alternatively may be configured to request and receive KPAs directly from user input. One or more key performance indicators may be established. A KPI may establish a measure of a status of a CSF.

A KPI may include specifically defined targets or “acceptable ranges” that may be met or maintained in order for a goal to be achieved. In the above example, where a goal is set to reduce the company's costs by 20% in three years, and a CSF is defined as reducing the number of employees, a KPI may establish a percentage by which employee numbers may be reduced. For example, a KPI may be set as reducing employee numbers by 5% in the first year. Data may be acquired from the enterprise or organization to determine whether the KPI is being achieved.

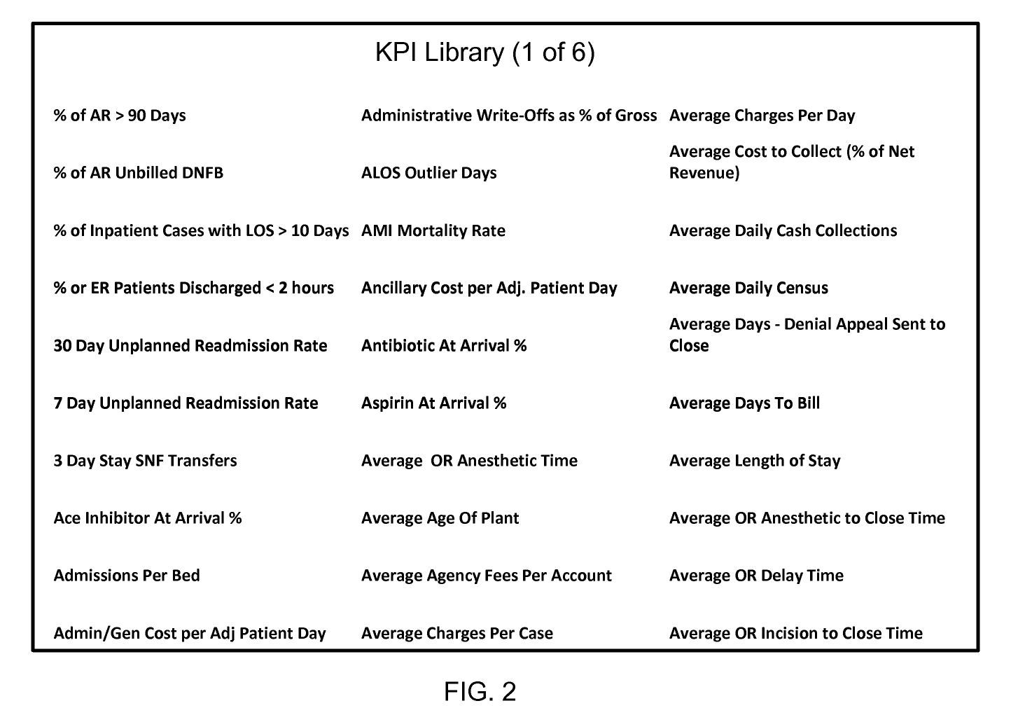

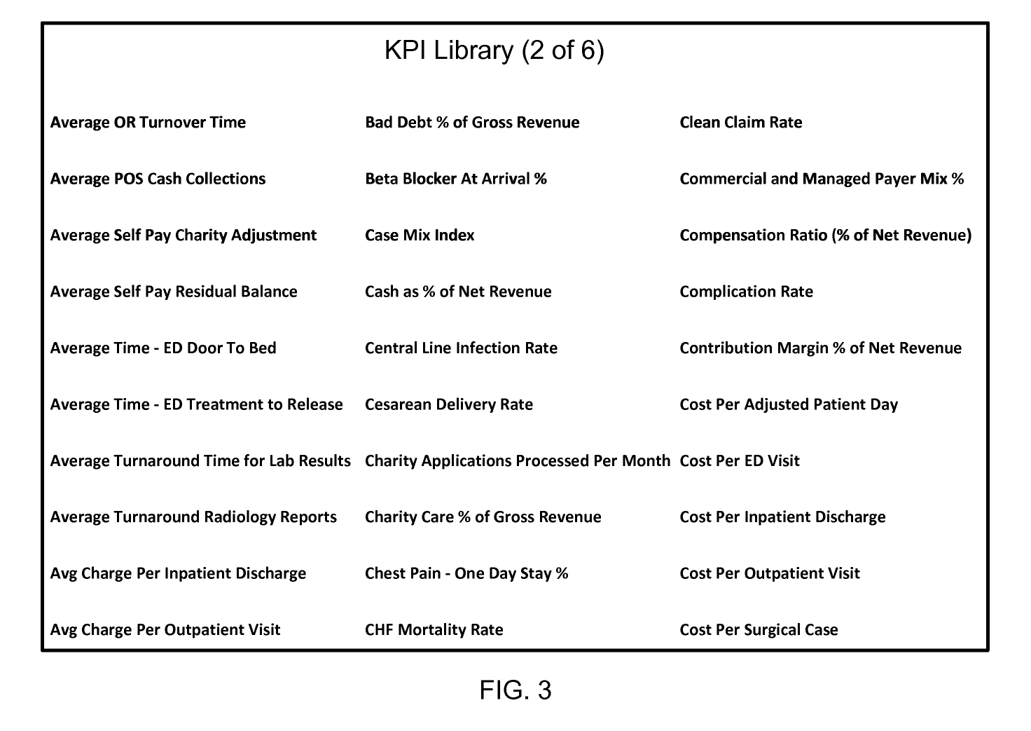

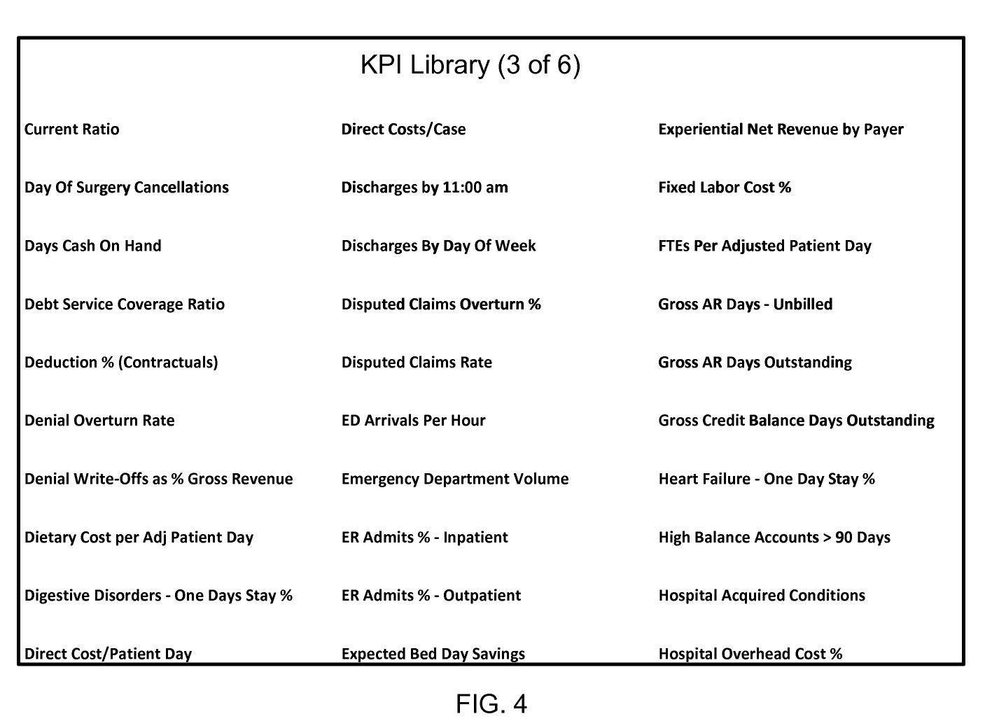

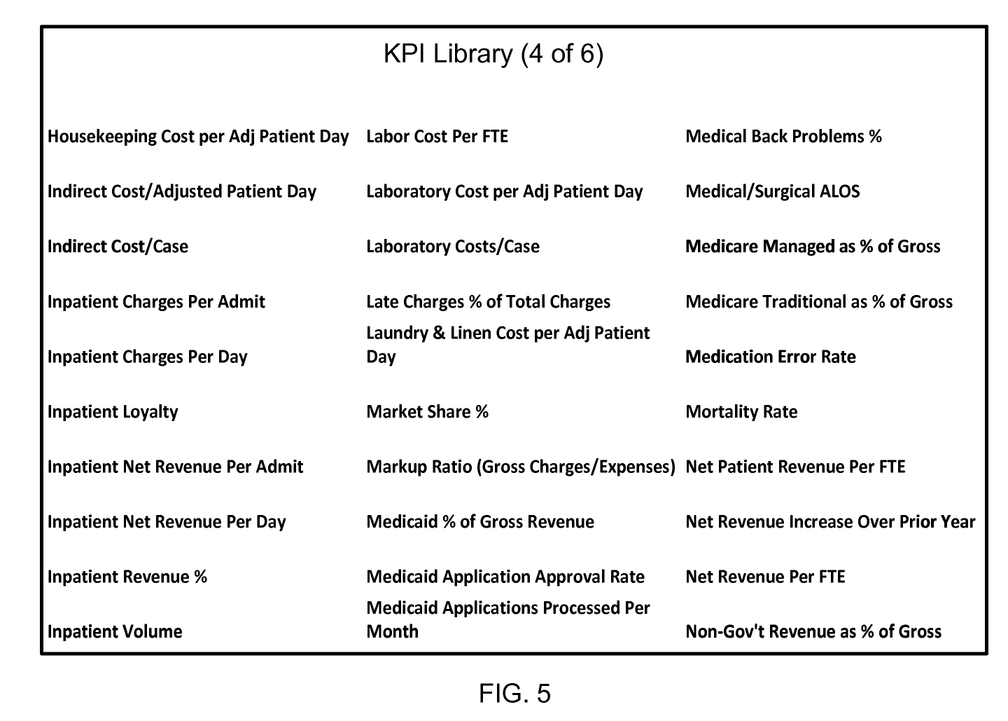

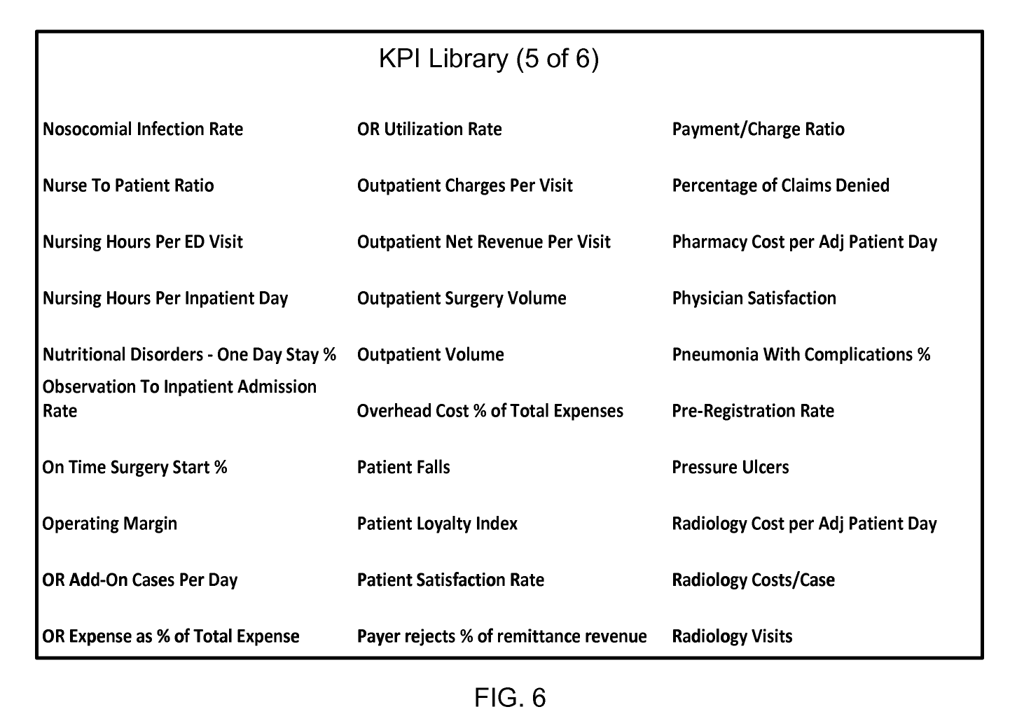

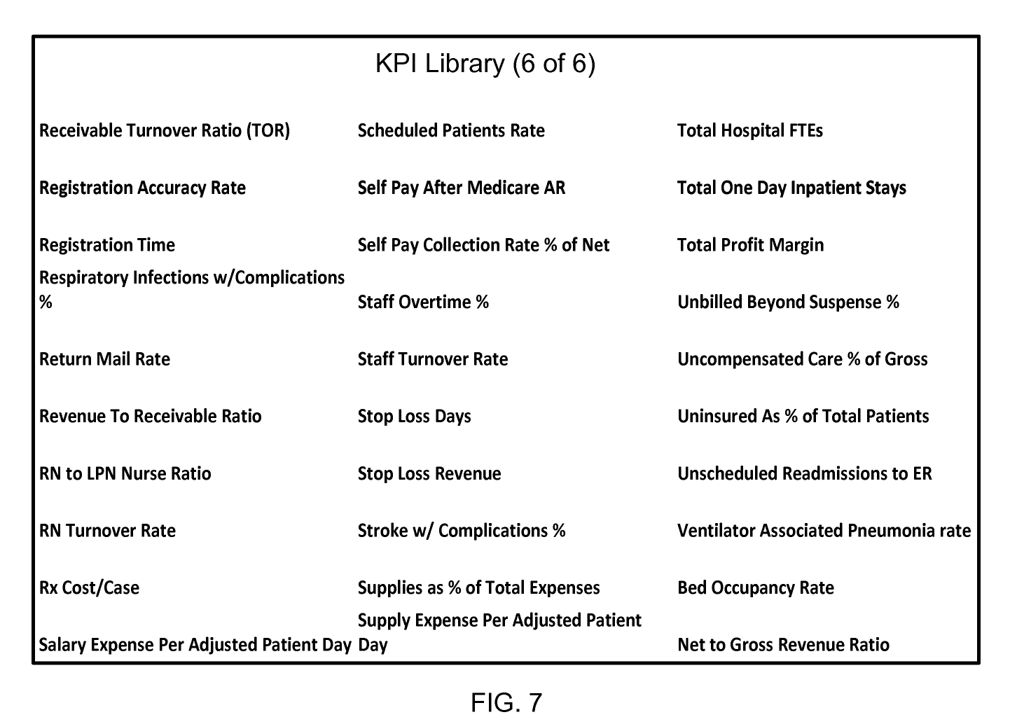

In an embodiment, KPI's for various business models may be compiled into libraries. In this embodiment, a healthcare business such as a hospital would be served by a library specific to healthcare organization and another business, such as a manufacturing entity, may be served by a different library. Such libraries may be used to allow users in each specified field to have access to pre-determined KPI's which they may use for creating their business goals. FIGS. 2-7 illustrate exemplary KPIs assembled in a KPI library for a healthcare business.

Each CSF may be associated with a series of action steps that are to be achieved within a timeline by a designated leader. Accordingly, the SPM server device 104 may be configured with software instructions to request action plan steps from the user. Action plan steps may include the actions that an enterprise may take to achieve either the intermediary on the final goals. For example, a company that plans to reduce costs by 20% in three years may consider taking actions such as reducing the total workforce at the company, renegotiating supplier contracts, outsourcing healthcare organization operations, and not renewing unnecessary service contracts.

An action item is scored as to whether it is complete or incomplete. The score of an action item is used as input to determine a score for a related CSF and goal. In an embodiment, the score is determined from information obtained from a user of the optimization system 100. For example, a user may be prompted to indicate the state of an action item as follows:
This Action Step is not scheduled to begin yet.
This Action Step was scheduled to begin, but has not started.
This Action Step is not progressing as anticipated, and is behind schedule.
This Action Step is progressing on schedule, but runs the risk of not being completed by the target date.
This Action Step is progressing on schedule and is expected to complete on-time with the desired outcome.
This Action Step has been successfully completed.

The scores for action items relating to a CSF may be averaged to determine the status or score of the CSF. The scores of CSFs related to a particular goal may be averaged to determine the status or score of the goal. As will be described below, the scores may be adjusted based on weighting factors.

The status of a KPI is not determined by the scoring of action steps, CSFs and goals. Rather, the status of a KPI is determined from data acquired from the enterprise or organization. If status of the goals indicates that an enterprise or organization is operating effectively but the status of the KPIs suggests a contrary state, the action items and/or the CSFs require revision or the KPIs require revision.

In an embodiment the SPM server device 104 may be configured with software instructions to operate a rules engine that retrieves action plan steps from one or several databases that store predetermined action steps, such as an action plan database 112. The action plan steps may be used to create an action plan for achieving the intermediary or final goals. In an embodiment, the action plan steps that are retrieved by the rules engine may depend on the specific type of enterprise or organization to which the optimization system 100 is being applied. For example, action plan steps for reducing costs in a department of a local hospital may be different than those of a different department in a regional hospital. Accordingly, the data stored in the action plan database 112 may be categorized to include different actions steps for different types of enterprises and organizations.

The SPM server device 104 may also be configured with software instructions to convert each strategic performance data into multiple data displays based on integrating scoring and weights assigned. The displays may be keyed to the type of enterprise or organization to which the optimization system 100 is being applied.

In an embodiment, the SPM server device 104 may also be configured with software instructions to prioritize CSFs and key performance indicators. Prioritization of CSFs and KPI's may include setting weighting algorithms in background and time sequencing. For example, an optimization system 100 may offer priority weighting possibilities for each CSF based on past experience and enterprise/organization type. The optimization system 100 may then expect that the success factors be met in the order of their priority. If the order of priority is not met, the optimization system 100 may be configured by software instructions issue an alert.

In an embodiment, the system allows for the fact that not all CSFs are of equal priority and provides an indication of whether high priority items are receiving appropriate attention. For example, while an Action Item Progress Score might help with the discipline of implementation and reporting progress, the score may not be as important as a review of CSF progress, and particularly progress in meeting high priority CSFs. Thus, embodiments illustrated herein, may be adjusted appropriately for priority settings.

In an embodiment, the SPM server device 104 comprises software instructions to execute an algorithm generator that establishes a priority weighting of CSF's. The algorithm generator utilizes information provided by a user of the optimization system 100 to determine how progress in completing an action item associated with a CSF is to be scored. In an embodiment, the user provides answers to questions proffered in a questionnaire. The answers are evaluated by the algorithm generator to produce a scoring algorithm. The algorithm generator may be executed by one or more processors (see, FIG. 12). By way of example, priority setting for CSF may be established as follows:
Are other strategic performance goals or other Critical YES_NO_uccess Factors dependent on early progress with this CSF?
Will success with this CSF allow an effective response YES_NO_to a quality or safety issue?
Are there risks of patient dissatisfaction or lower YES NO physician commitment, if early progress with this CSF is not made?
Is the CFS required to meet financial goals?YES_NO_{—}

Users of the system may answer “YES” or “NO” to one or all of the conditions stipulated above. It should be noted that these conditions are merely examples of what may be presented. Other conditions may also be presented to the user to assist in the prioritizing function.

After entry of the sample conditions noted above, the algorithm generator operating on SPM server device 104 produces priority weighting factors for the CSFs. By way of illustration and not by way of limitation, the priority weighting factors may be established as follows:
If a user selects only the condition that other CSFs depend on the one being entered, the priority rating will default to 1.15 as a minimum weight. This is based on the critical assumption that other performance goals will be impeded without accelerated progress in this area.
If the user selects only one from the list above, other than dependence of subsequent CSFs, the priority weighting would be 1.10.
If the user selects any two conditions, the priority weighting would be 1.15.
If the user selects any three conditions from the list characterizing the CSF, the established weight would be 1.20.
If the user selects four conditions, the weight would be 1.30.

The weights assigned above are exemplary and are presented to illustrate how a weighting function may be established. In practice, the weighting factors may be determined by data acquired over time may depend on the business model of the user of the optimization system 100. In an embodiment, answers to the questionnaire are mandatory in order for the configuration of the optimization system 100 to proceed. In another embodiment, when the answers to the questions are not provided, the weighting factors default to 1.0 (i.e., no weighting).

Once the CSF has a priority weighting established, the weightings operate in the background, functioning as multipliers to adjust the scores obtained for action items and CSFs as previously described. The results allow for creation of an adjusted “Performance Score” for each CSF. In this manner a system user is not misled by significant progress on Action Steps that might be underway that relate to easier or lower priority CSFs. The setting of CSF priority allows creation of a list of the high priority CSF, as well as a list of the highest priority CSFs, with the lowest adjusted progress scores, etc.

In an embodiment, the ultimate adjusted CSF Performance Score may be driven initially by the Action Progress Score numbers.

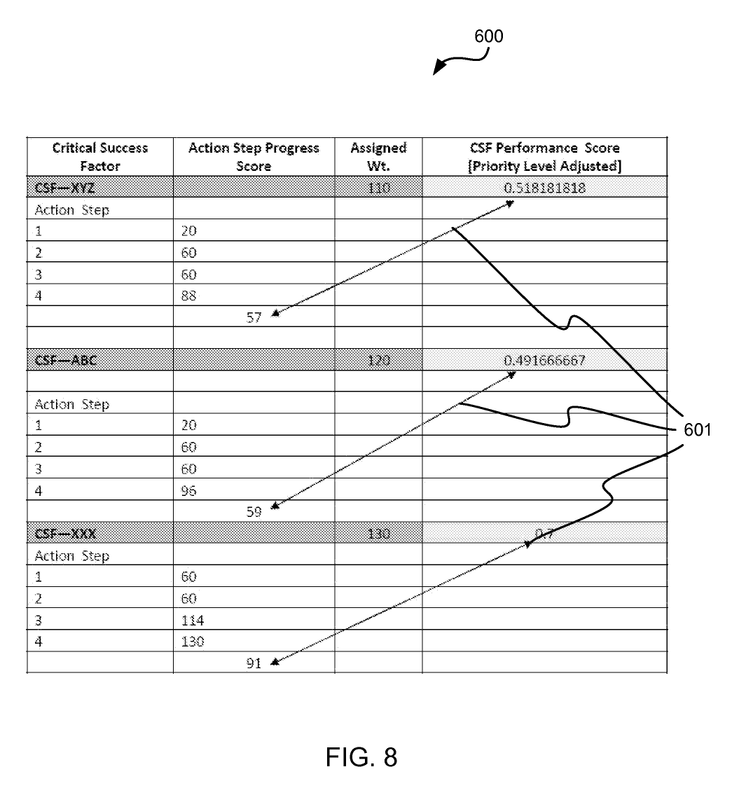

In an exemplary embodiment as illustrated in FIG. 8, Table 600 illustrates the calculation of a CSF performance score based on different CSFs and action step progress scores and assigned weights parameters. For example, the progress scoring may be performed for the action steps related to each CSF on a periodic basis. The action step progress score for each CSF may create a sample means score. Any action step score that achieves the action step under the CSF may be automatically adjusted upward based on the priority weighting. This may create incentives to move tasks associated with these CSFs more expeditiously. For example, as indicated in Table 600 for CSF-XYZ, the action step progress score may be “88” instead of “80” if the related CSF was weighted at the 1.10 Assigned Wt. level. The actions step scores are then averaged and the average core may be factored against the established assigned weighting (i.e., priority weighting) to display an adjusted CSF performance score. In another example relating to CSF-XXX, the progress score of 91 may be adjusted to calculate a CSF performance score of 0.7 (or 70) to direct the attention of the goal leaders to the progress or lack of progress in achieving the goals set forth for CSF-XXX.

The arrows 601 in Table 600 show that the actual performance score for the CSF may be adjusted to reflect the priority rating, and indicate that more leadership action or resources or additional Action Steps may be required for successful completion of this goal.

Table 600 is an example of the type of information that may be included in such tables. Other Table variations are contemplated which, for example, may include or exclude rows or columns as shown in Table 600. For example, a list of CSFs within their categories of weighting with their current action step progress scores may be shown. Further, a “high alert” list of CSFs with high priority weightings and low scores may also be shown. In an exemplary embodiment, different graphical user interfaces may be used to alert the user to the priority level of the CSF Performance Score. For example, red color may be used for priority scores between 0 and 39. Yellow color may be used for priority scores between 40 and 70 and green color may be used for priority scores between 71 and 100.

In an embodiment, the OPM server device 106 may also be configured with software instructions to process and analyze the strategic performance objectives and determine the qualities of a leader who can manage and achieve those objectives. The OPM server device 106 may then assign qualified leaders to each objective. In assigning qualified leaders to objectives, the OPM server device 106 may query a Human Resources (HR) database 118. Employees' personal and professional information and qualifications may be stored in a HR database 118. By retrieving HR information about employees of the enterprise and comparing that data to the qualifications required to manage a certain project, the OPM server device 106 may be able to identify and match the most qualified persons to manage each objective. If the enterprise or organization does not employ a qualified person, the OPM server device 106 may provide a set of qualifications by which the enterprise may search for and hire a qualified employee. Alternatively, or additionally, qualifications required for each project may be requested and received by the OPM server device 106 through data input by leaders of the enterprise or organization. OPM server device 106 may then use the inputted data to select qualified employees to lead or manage projects.

In an embodiment, the OPM server device 106 may also be configured with software instructions to monitor the progress of objectives and performance of action steps. In one embodiment, the OPM server device 106 may request and receive metrics information, such as accounting data, from the user or a metrics database 114. For example, final quarterly or annual accounting data may be stored in a metrics database 114. The accounting data may then be retrieved by the OPM server device 106 to determine whether the costs of the enterprise or organization have reduced and by what amount. For example, the accounting data may indicate that healthcare organization costs have increased over the quarter and such increase does not commensurate with an intermediary goal of 5% reduction at each quarter. In such a scenario, the OPM server device 106 may inform the managers of this unplanned increase in costs and may require the managers to devise new action plan steps to remedy this problem for the next quarter.

In another embodiment, OPM server device 106 may also suggest new action plan steps to remedy the problem. In analyzing this problem, the OPM server device 106 may also determine whether all the action plans steps were completed for that given quarter and suggest new actions steps or new and more realistic goals for the enterprise or organization. The OPM server device 106 may be configured with software instructions to determine missing metrics data and to suggest to the users the type of metrics equipment or tools that may be required to generate the required metrics data.

In another embodiment, the OPM server device 106 may track the progress towards a goal by requesting and receiving progress data from leaders and managers of each objective. The OPM server device 106 may be configured with software instructions to periodically request information from managers about the progress towards achieving an objective. The data may be received and stored in the OPM server device 106 and used to measure progress. For example, a manager may report that certain actions steps have been completed and that certain goals have been achieved. Such data may be received by the OPM server device 106 and implemented to allow the OPM server device 106 to continue monitoring the progress of the enterprise or organization towards its goals. Accordingly, the OPM server device 106 may be configured with software instructions to receive and analyze manager or leader notes and assign the data to an appropriate field and use the data to determine, for example, whether CSFs or KPI's are achieved.

In another embodiment, OPM server device 106 may receive data automatically as that data is generated. For example, if a personnel reduction in a particular department is desired, the OPM server device 106 may track information from HR database 118 and determine when an employee has resigned, been dismissed or retired from a particular department. Such information would then be recorded by OPM server device 106 as a step in the reduction of the workforce in that particular department. In so doing, OPM server device 106 minimizes the activities of the department manager. In another embodiment, the OPM server device 106 may alert an individual in the HR department that if the position that was vacated is subsequently filled, the filling of the position will impact the achievement of the goal of reducing costs and the KPIs and the CSFs related to that goal.

In addition to using metrics and user notes, the OPM server device 106 may monitor other parameters to track performance of an enterprise. One parameter that the OPM server device 106 may employ to track performance is completion of CSFs. Accordingly, the OPM server device 106 may be configured with software instructions to track achievement of CSFs for each strategic goal. Whether a CSF is achieved depends on whether the key performance indicators for that critical factor are met. Therefore, the OPM server device 106 may also be configured with software instructions to determine whether the enterprise or organization has met or maintained set key performance indicators (KPI). For example, when the company has a goal to reduce costs by 20% in three years, the company may designate a CSF as reducing the number of the employees. The KPI for the CSF may be the percentage by which employees must be reduced. For instance, a CSF may be successfully accomplished when employees of the enterprise are reduced by 10%. Accordingly, to track performance and achievement of goals, the OPM server device 106 may use metrics, user notes and analytical tools to determine whether key performance indicators are achieved which in turn may indicate successful completion of critical factors. Achievement or failure to achieve critical factors may be evaluated to determine the success of the enterprise or organization in achieving its goals.

In an embodiment, the OPM server device 106 may be configured to track completion of CSFs using different yet related measures. For example, KPI data input or direct “feeds,” progress updates, which are scored by accountable leaders and target dates set pre CSF establishment may be used to create an execution scoreboard and input into a weighted algorithm to assign priority and reflect progress based on the outcome. The scoreboard may include a graphical user interface which may allow users to interact with the systems of the various embodiments. For example, KPI's or other parameters may be displayed on the scoreboard to allow the user to view and assign priority to them. Users may also customize the scoreboards to display data based on user preferences.

The OPM server device 106 may also track progress of an enterprise or organization towards its goals by producing and analyzing data. Accordingly, the OPM server device 106 may be configured with software instructions to use metrics and manager notes data to generate analytical data by using analytical tools. Such information may be stored in an analytical tools database 116. Analytical tools may include quality tools, such as, “Five Whys” questioning techniques in determining root causes. The OPM server device 106 may be configured with software instructions to determine missing analytical data, and to suggest to the users, the type of analytical tools and equipment that may be required to generate the desired analytical data. In another embodiment, and in the event of missing data, OPM server device 106 may send a message to a particular user to provide the missing data that will then allow the analysis to occur.

In an embodiment, the optimization system 100 may also include an Operational Performance Management (OPM) server device 106 that may be configured with software instructions for issuing alerts to selected individuals or device regarding variances on key performance indicators. In this embodiment, when it appears to the system as if a key performance indicator is not within an acceptable range, the system notifies the appropriate individual or device based upon the performance indicator that is driving the alert.

The OPM server device 106 may be configured with software instructions to alert readers or managers regarding the progress of the enterprise or organization towards its final goals. For example, alerts and notifications to employees associated with a goal may be sent based on criticality and category of objectives. Criticality may be determined based on the weight that is given to an action item, such as a CSF, as described above. The OPM server device 106 may also be configured with software instructions to use progress scoring methodology as discussed above. The optimization system 100 may also include a performance improvement management (PIM) server device 108 which may be configured by software instructions to provide a dynamic and practical action planning, tracking and reporting tool for managers and teams to be used to organize, guide and accelerate the successful execution of focused performance improvement initiatives. The software instructions for providing the action planning, tracking and reporting tool may be executed by one or more processors (see, FIG. 12). Accordingly, the PIM server device 108 may be configured with software instructions to allow an enterprise or organization to improve performance based on data received from the SPM server device 104 and OPM server device 106. For example, the PIM server device 108 may provide alternative or additional action steps to take based on current state of progress or strategic performance. The PIM server device 108 may analyze performance or lack of performance to provide guidance to users for achieving objectives.

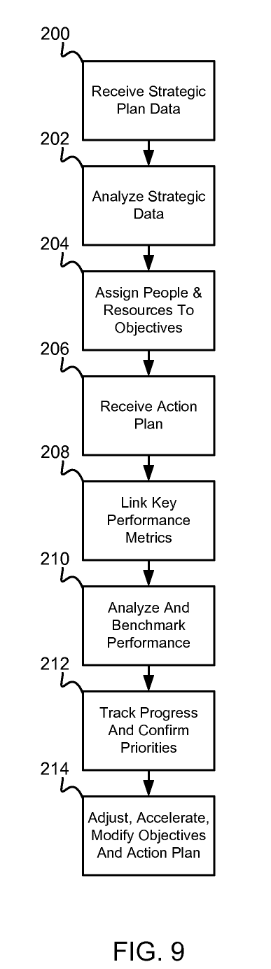

FIG. 9 illustrates a process flow diagram for optimizing performance of an enterprise or organization according to the various embodiments. An optimization system 100 may receive strategic plan data which may include a variety of data such as strategic goals for optimizing performance and operations of the enterprise or organization, CSFs and KPI's, block 200. Alternatively, CSFs and KPI's may be suggested to the user by the system and thereafter be approved by a user. The optimization system 100 may then analyze the strategic plan data, block 202. In analyzing the strategic data, the optimization system 100 may process and categorize goals and objectives, CSFs and KPI's and identify and assign qualified personnel to lead different objectives, block 204. The optimization system 100 may then use a rules engine to automatically generate based upon rules for the organization type, are or receive action plans which may include actions steps that may be achieved before each goal is realized, block 206. Based on the data received and analyzed, the optimization system 100 may determine which metrics may be required to monitor progress for each objective and may link key performance metrics based on the data, block 208. Using the metrics data received, performance may be analyzed and benchmarked by employing analytical tools, block 210. The overall progress may also be monitored to ensure that goals are achievable within the set parameters and timelines and that correct priorities are set, block 212. Depending on the progress towards achieving the goal the optimization system 100 may suggest or automatically implement adjustments or modifications to objectives and action plans to maintain course or accelerate achievement of goals, block 214.

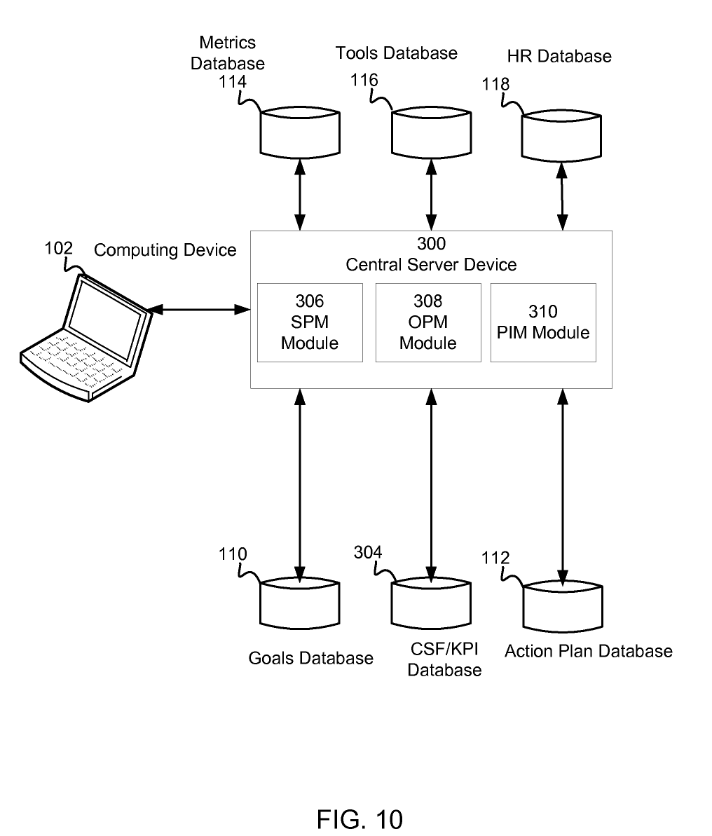

FIG. 10 illustrates a system component diagram of a centralized optimization system according to an embodiment. A central server device 300 may be used to optimize organizational performance. The central server device 300 may include modules such as a strategic performance management module 306, an operations performance management module 308, and a performance improvement management module 310. The function of each module may be similar to the function of the server devices 104, 106 and 108 described above with respect to FIG. 1. The central server device 300 may be configured with software instructions to communicate with several databases such as goals database 110, action plan database 112, CSF/KPI database 304, metrics database 114, and analytical database 116, and HR database 118. The central server device 300 may also be configured with software instructions to communicate with the user by communicating with a computing device 102 via a wire, wireless, or Internet connections. Other connections are known as contemplated. The computing device 102 may be configured with software instructions to receive data from the central server device 300 and display the data to the user using a graphical user interface. The use of graphical user interface to display data is well known.

In an embodiment, the optimization system 100 may be operated by an enterprise or an organization for its own use. In another embodiment, the optimization system 100 may be operated at central location and accessed by an enterprise or an organization via a network, such as the Internet (not illustrated).

In an embodiment, the optimization system 100 may be offered as a product for sale to a user. In another embodiment, access to the optimization system 100 may be sold to a user as a service.

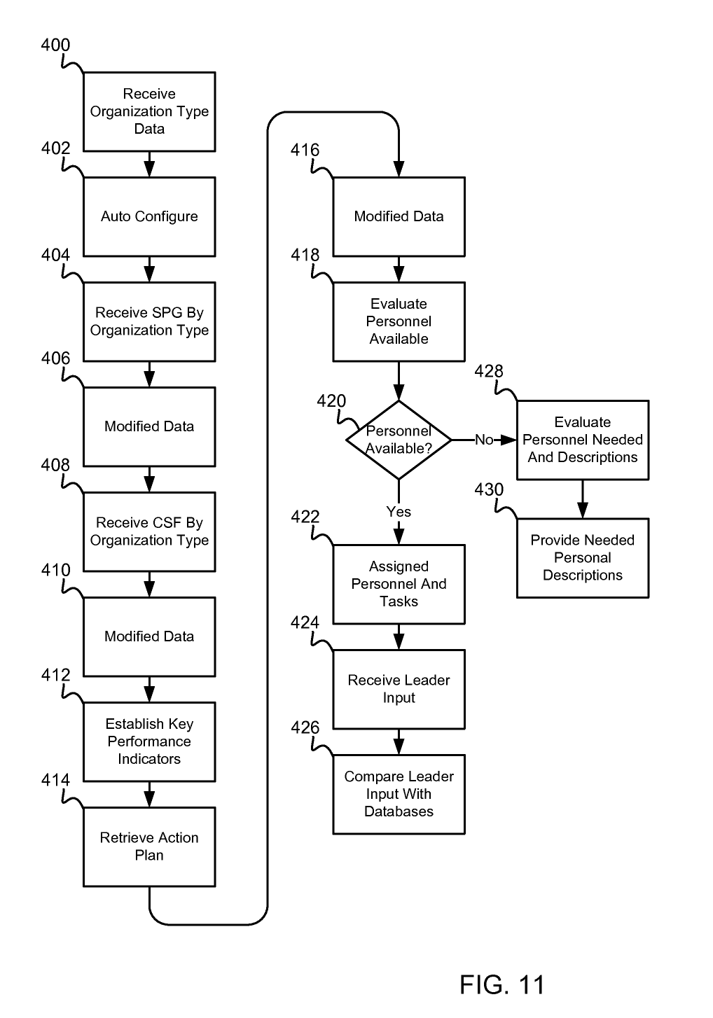

FIG. 11 illustrates a process flow diagram of an exemplary embodiment for optimizing the performance of an enterprise or organization by receiving from the user only information about enterprise or organization type and automatically creating optimization plans for that enterprise or organization based on the that type. The optimization system 100 may request and receive input from the user about the enterprise or organization type, block 400. The data received may be auto-configured, block 402, and based on the enterprise or organization type, the optimization system 100 may request and receive strategic performance goals (SPG) from the goals database 110, block 404. The user may modify the SPG goals received based on the user's preferences, block 406, and the optimization system 100 may request and receive CSFs from a CSF database based on the enterprise or organization type, block 408. The user may modify the CSF data received based on the user's preferences, block 410, and key performance indicators may be established for each CSF, block 412. KPI's for the enterprise or organization type may be stored and retrieved from a KPI database. The optimization system 100 may then retrieve action plans, block 414, based on the goals, CSF, and KPI data received from different databases. User may modify the action plan data based on the user's preferences, block 416. The optimization system 100 may then evaluate the personnel available in the enterprise or organization by accessing and HR database 118, block 418, based on the enterprise or organization type, the goal and other relevant information to determine whether qualified personnel are available, determination 420. If qualified personnel is available, determination 420=“Yes,” the optimization system 100 may assign the personnel to the project, block 422. If qualified personnel is not available, determination 420=“No,” the optimization system 100 may value with the type of personnel that is needed and create a list of descriptions and qualifications for that person now, block 428, and provide that list of qualifications to the enterprise, block 430. The enterprise may use the list of qualifications to either hire a qualified person to lead the project or assign a person who may be closely qualified to the project. To further monitor the progress towards achieving the goals the optimization system 100 may request and receive input from the project leader, block 424, and compare the leader inputted information to data from other databases such as the goals database 110, CSF/KPI database 304 and action plan database 112, block 426.

A number of the embodiments described above may also be implemented with any of a variety of remote server device devices, such as the server device 2400 illustrated in FIG. 12. Such a server device 2400 typically includes a processor 2401, coupled to volatile memory 2402, and a large capacity nonvolatile memory, such as a disk drive 2403. The server device 2400 may also include a floppy disc drive and/or a compact disc (CD) drive 2406 coupled to the processor 2401. The server device 2400 may also include network access ports 2404 coupled to the processor 2401 for establishing data connections with network circuits 2405, such as the Internet.

The embodiments described above may also be implemented on any of a variety of computers, such as a personal computer 1310 illustrated in FIG. 13. Such a personal computer 1310 typically includes a processor 1361 coupled to volatile memory 1362 and a large capacity nonvolatile memory, such as a disk drive 1363. The computer 1310 may also include a floppy disc drive 1363 and a compact disc (CD) drive 1366 coupled to the processor 1361. Typically the computer 1310 will also include a pointing device such as a mouse 1350, a user input device such as a keyboard 1340 and a display 1360. The computing device 1300 may also include a number of connector ports 1365 coupled to the processor 1361 for establishing data connections or network connections or for receiving external memory devices, such as a USB or FireWire® connector sockets. While the computing device 1300 is illustrated as using a desktop form factor, the illustrated form is not meant to be limiting. For example, some or all of the components of computing device 1300 may be implemented as a desktop computer, a laptop computer, a mini-computer, or a personal data assistant. In a notebook configuration, the computer housing includes the pointing device 1350, keyboard 1340 and the display 1360 as is well known in the computer arts. The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The blocks of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server device, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein, but is to be accorded the widest scope consistent with the following claims and the principles and novel features disclosed herein.

What is claimed is:

1. An enterprise optimization system comprising:
a computing device, wherein the computing device is connected to a central server;
the central server, wherein the central server comprises a processor and wherein the processor is configured with software executable instructions to cause the central server to perform operations comprising:
receiving from the computing device a goal;
receiving from the computing device a critical success factor relating to the goal, wherein the critical success factor comprises a task the completion of which is required to achieve a particular goal;
receiving from the computing device an action step and a timeline for completing the action step, wherein the action step comprises a task the completion of which is required to achieve the critical success factor;
receiving from the computing device information relating to the completion of the action step; and
determining a first measure of attainment of the critical success factor and a second measurement of attainment of the goal from the action step completion information.

2. The system of claim 1, wherein the enterprise is selected from the group consisting of a healthcare enterprise, a manufacturing enterprise, a service enterprise, a non-profit organization, a not-for-profit organization, and a governmental agency.

3. The system of claim 1, wherein the processor is further configured with software executable instructions to cause the central server to perform operations comprising:
establishing a priority for the critical success factor;
establishing a weighting factor for the critical success factor, and
adjusting the measure of attainment of the goal using the weighting factor.

4. The system of claim 3, wherein the operation for establishing a weighting factor for the critical success factor comprises:
prompting a user of the computing device for first information indicative of a relationship between the goal and another goal; and
prompting the user of the computing device for second information indicative of a relationship between the critical success factor and another critical success factor; and
establishing the weighting factor using the first and second information.

5. The system of claim 1, wherein the processor is further configured with software executable instructions to cause the central server to perform operations comprising:
identifying a key performance indicator, wherein the key performance indicator measures the achievement of the critical success factor;
establishing an acceptable range for the key performance indicator;
determining whether the key performance indicator is within the acceptable range; and
issuing an alert if the key performance indicator is outside the acceptable range.

6. The system of claim 5, wherein the goal comprises an achievement date and wherein the acceptable range is reduced as the achievement date is approached.

7. The system of claim 1, wherein the processor is further configured with software executable instructions to cause the central server to perform operations comprising;
establishing an acceptable range for the measure of attainment;
determining whether the measure of attainment is within the acceptable range; and
establishing an additional action step from the action step information and the performance state information when the measure of attainment is outside the acceptable range.

8. The system of claim 1, wherein the processor is further configured with software executable instructions to cause the central server to perform operations comprising:
receiving information identifying an individual responsible for attainment of the goal; and
associating the goal with the responsible individual.

9. A method for optimizing the optimizing the operation of an enterprise comprising:
a processor receiving a goal from a computing device;
the processor receiving from the computing device a critical success factor relating to the goal, wherein the critical success factor comprises a task the completion of which is required to achieve a particular goal;
the processor receiving from the computing device an action step and a timeline for completing the action step, wherein the action step comprises a task the completion of which is required to achieve the critical success factor;
processor receiving from the computing device information relating to the completion of the action step; and
processor determining a first measure of attainment of the critical success factor and a second measurement of attainment of the goal from the action step completion information.

10. The method of claim 9, wherein the enterprise is selected from the group consisting of a healthcare enterprise, a manufacturing enterprise, a service enterprise, a non-profit organization, a not-for-profit organization, and a governmental agency.

11. The method of claim 9 further comprising:
the processor establishing a priority for the critical success factor;
the processor establishing a weighting factor for the critical success factor, and
the processor adjusting the measure of attainment of the goal using the weighting factor.

12. The method of claim 11, wherein the processor establishing a weighting factor for the critical success factor comprises:
the processor prompting a user of the computing device for first information indicative of a relationship between the goal and another goal;
the processor prompting the user of the computing device for second information indicative of a relationship between the critical success factor and another critical success factor; and
the processor establishing the weighting factor using the first and second information.

13. The method of claim 9 further comprising:
the processor identifying a key performance indicator, wherein the key performance indicator measures the achievement of the critical success factor;
the processor establishing an acceptable range for the key performance indicator;
the processor determining whether the key performance indicator is within the acceptable range; and
the processor issuing an alert if the key performance indicator is outside the acceptable range.

14. The method of claim 13, wherein the goal comprises an achievement date and wherein the acceptable range is reduced as the achievement date is approached.

15. The method of claim 9 further comprising;
the processor establishing an acceptable range for the measure of attainment;
the processor determining whether the measure of attainment is within the acceptable range; and
the processor establishing an additional action step from the action step information and the performance state information when the measure of attainment is outside the acceptable range.

16. The method of claim 9 further comprising:
the processor receiving information identifying an individual responsible for attainment of the goal; and
the processor associating the goal with the responsible individual.

17. An enterprise optimization system comprising:
a goals database;
a critical success factor database;
an action plan database;
a computing device, wherein the computing device is connected to a central server;
the central server, wherein the central server comprises a processor and wherein the processor is configured with software executable instructions to cause the central server to perform operations comprising:
receiving from the computing device an organizational category;
receiving from the goals database a goal related to the organization category;
receiving from the critical success factor database a critical success factor relating to the goal and to the organizational category, wherein the critical success factor comprises a task the completion of which is required to achieve a particular goal;
receiving from the action plan database an action step and a timeline for completing the action step, wherein the action step is related to the organizational category and associated with the critical success factor;
receiving from the computing device information relating to the completion of the action step; and
determining a measure of attainment of the goal from the action step information and the performance state information.

18. The system of claim 17, wherein the enterprise is selected from the group consisting of a healthcare enterprise, a manufacturing enterprise, a service enterprise, a non-profit organization, a not-for-profit organization, and a governmental agency.

19. The system of claim 17, wherein the processor is further configured with software executable instructions to cause the central server to perform operations comprising:
establishing a priority for the critical success factor;
establishing a weighting factor for the critical success factor, and
adjusting the measure of attainment of the goal using the weighting factor.

20. The system of claim 19, wherein the operation for establishing a weighting factor for the critical success factor comprises:
prompting a user of the computing device for first information indicative of a relationship between the goal and another goal;
prompting the user of the computing device for second information indicative of a relationship between the critical success factor and another critical success factor; and
establishing the weighting factor using the first and second information.

21. The system of claim 17, wherein system further comprises a key performance indicator database and the processor is further configured with software executable instructions to cause the central server to perform operations comprising:
receiving from the key performance indicator database a key performance indicator, wherein the key performance indicator is related to the organizational category and measures the completion of the critical success factor;
establishing an acceptable range for the key performance indicator;
determining whether the key performance indicator is within the acceptable range; and
issuing an alert if the key performance indicator is outside the acceptable range.

22. The system of claim 21, wherein the key performance indicator comprises an achievement date and wherein the acceptable range is reduced as the achievement date is approached.

23. The system of claim 17, wherein the processor is further configured with software executable instructions to cause the central server to perform operations comprising;
establishing an acceptable range for the measure of attainment;
determining whether the measure of attainment is within the acceptable range; and
establishing an additional action step from the action step information and the performance state information when the measure of attainment is outside the acceptable range.

24. The system of claim 17, wherein the goals database comprises qualifications information indicative of a set of skills required to manage the goal and wherein the processor is further configured with software executable instructions to cause the central server to perform operations comprising:
accessing a human relations database, wherein the human relations database comprises information relating to skills of individuals within the enterprise;
matching the skills of the individuals within the enterprise to the required skill set; and
assigning responsibility for the goal to an individual whose skills match the required skill set.

25. A method for optimizing an enterprise comprising:
a processor receiving from a computing device an organizational category;
the processor receiving from a goals database a goal related to the organization category;
the processor receiving from a critical success factor database a critical success factor relating to the goal and to the organizational category, wherein the critical success factor comprises a task the completion of which is required to achieve a particular goal;
the processor receiving from an action plan database an action step and a timeline for completing the action step, wherein the action step is related to the organizational category and associated with the critical success factor;
the processor receiving from the computing device information relating to the completion of the action step; and
determining a measure of attainment of the goal from the action step information and the performance state information.

26. The method of claim 25, wherein the enterprise is selected from the group consisting of a healthcare enterprise, a manufacturing enterprise, a service enterprise, a non-profit organization, a not-for-profit organization, and a governmental agency.

27. The method of claim 25 further comprising:
the processor the processor establishing a priority for the critical success factor;
establishing a weighting factor for the critical success factor, and
the processor adjusting the measure of attainment of the goal using the weighting factor.

28. The method of claim 27, wherein establishing a weighting factor for the critical success factor comprises:
the processor prompting a user of the computing device for first information indicative of a relationship between the goal and another goal;
the processor prompting the user of the computing device for second information indicative of a relationship between the critical success factor and another critical success factor; and
establishing the weighting factor using the first and second information.

29. The method of claim 25 further comprising:
the processor receiving from a key performance indicator database a key performance indicator, wherein the key performance indicator is related to the organizational category and measures the completion of the critical success factor;
the processor establishing an acceptable range for the key performance indicator;
the processor determining whether the key performance indicator is within the acceptable range; and
the processor issuing an alert if the key performance indicator is outside the acceptable range.

30. The method of claim 29, wherein the key performance indicator comprises an achievement date and wherein the acceptable range is reduced as the achievement date is approached.

31. The method of claim 25 further comprising;
the processor establishing an acceptable range for the measure of attainment;
the processor determining whether the measure of attainment is within the acceptable range; and
the processor information when the measure of attainment is outside the acceptable range.

32. The method of claim 25, wherein the goals database comprises qualifications information indicative of a set of skills required to manage the goal and wherein the method further comprises:
the processor accessing a human relations database, wherein the human relations database comprises information relating to skills of individuals within the enterprise;
the processor matching the skills of the individuals within the enterprise to the required skill set; and
the processor assigning responsibility for the goal to an individual whose skills match the required skill set.
